(19) United States
(12) Patent Application Publication
(10) Pub. No.: US 2021/0312465 A1
(43) Pub. Date: Oct. 7, 2021

(54) TRANSACTION PROCESSING METHOD, APPARATUS, DEVICE, MEDIUM AND SYSTEM

(71) Applicant: CHINA UNIONPAY CO., LTD., Shanghai (CN)

(72) Inventors: Xiaonan HOU, Shanghai (CN); Yuemin QI, Shanghai (CN); Shuo HE, Shanghai (CN); Sishuang WAN, Shanghai (CN); Xuetao QIU, Shanghai (CN); Yang YANG, Shanghai (CN)

(73) Assignee: CHINA UNIONPAY CO., LTD., Shanghai (CN)

(21) Appl. No.: 17/269,351

(22) PCT Filed: Jan. 14, 2020
(86) PCT No.: PCT/CN2020/071998

§ 371 Date: Feb. 18, 2021

(30) Foreign Application Priority Data
May 20, 2019 (CN) 201910417482.3

(51) Int. Cl. G06Q 20/40; G06K 9/00

(52) U.S. Cl. CPC G06Q 20/40145; G06K 9/00221; G06Q 20/405; G06Q 20/4018

(57) ABSTRACT

Transaction processing method, apparatus, device, medium and system are disclosed in the embodiments of the present application. The method includes: acquiring biometric characteristic information of a user; transmitting the biometric characteristic information to a target biometric information server, so that the target biometric information server determines card information of the user according to the biometric characteristic information for feedback; receiving the card information of the user fed back by the target biometric information server; transmitting a transaction request to an authorization server corresponding to the card information, so that the authorization server performs authorization verification on a transaction corresponding to the transaction request; receiving a transaction authorization verification result fed back by the authorization server; and performing the transaction according to the transaction authorization verification result.

### CROSS REFERENCE TO RELATED APPLICATIONS

The application is a National Stage of International Application No. PCT/CN2020/071998 filed on Jan. 14, 2020, which claims priority of the Chinese Patent Application No. 201910417482.3 filed on May 20, 2019 and entitled “Transaction Processing Method, Apparatus, Device, Medium and System”, both of which are incorporated herein by reference in their entireties.

### TECHNICAL FIELD

The application relates to the field of mobile payment technology, in particular to a transaction processing method, apparatus, device, medium and system.

### BACKGROUND

In the era of card-based payment, an issuing bank is in a dominant position in a payment market, and is able to perform authorization of a transaction as well as to grasp flow of a user's funds.

However, in the mode of mobile payment, a transaction can be carried out without authorization by an issuing bank, so security of a user's funds is lower and it is difficult for the issuing bank to grasp flow of the user' funds, which is not conducive to fund supervision.

### SUMMARY

The embodiments of the present application provide a transaction processing method, apparatus, device, medium and system, which can improve security of a user's funds.

In a first aspect, the embodiments of the present application provides a transaction processing method. The method includes: acquiring biometric characteristic information of a user; transmitting the biometric characteristic information to a target biometric information server, so that the target biometric information server determines card information of the user according to the biometric characteristic information for feedback; receiving the card information of the user fed back by the target biometric information server; transmitting a transaction request to an authorization server corresponding to the card information, so that the authorization server performs authorization verification on a transaction corresponding to the transaction request; receiving a transaction authorization verification result fed back by the authorization server; and performing the transaction according to the transaction authorization verification result.

In a second aspect, the embodiments of the present application provides a transaction processing method. The method includes: acquiring biometric characteristic information of a user; determining card information of the user according to the biometric characteristic information for feedback; and feeding back the card information to a terminal device, so that the terminal device transmits a transaction request to an authorization server corresponding to the card information, receives a transaction authorization verification result fed back by the authorization server in response to the transaction request, and performs a transaction according to the transaction authorize verification result.

In a third aspect, the embodiments of the present application provides a transaction processing method. The method includes: acquiring a transaction request, wherein the transaction request includes biometric characteristic information of a user and a transaction authorization verification mode depending on the biometric characteristic information; acquiring, from a target biometric information server, registered biometric characteristic information of the user required by the transaction authorization verification mode; performing authorization verification on a transaction corresponding to the transaction request according to the registered biometric characteristic information and the biometric characteristic information included in the transaction request to obtain a transaction authorization verification result; and feeding back the transaction authorization verification result to a terminal device that transmits the transaction request, so that the terminal device performs the transaction according to the transaction authorization verification result.

In a fourth aspect, the embodiments of the present application provides a transaction processing apparatus. The apparatus includes: a biometric characteristic information acquisition module configured to acquire biometric characteristic information of a user; a biometric characteristic information transmission module configured to transmit the biometric characteristic information to a target biometric information server, so that the target biometric information server determines card information of the user according to the biometric characteristic information for feedback; a card information reception module configured to receive the card information of the user fed back by the target biometric information server; a transaction request transmission module configured to transmits a transaction request to an authorization server corresponding to the card information, so that the authorization server performs authorization verification on a transaction corresponding to the transaction request; a transaction authorization verification result reception module configured to receive a transaction authorization verification result fed back by the authorization server; and a transaction module configured to perform the transaction according to the transaction authorization verification result.

In a fifth aspect, the embodiments of the present application provides a transaction processing apparatus. The apparatus includes: a biometric characteristic information acquisition module configured to acquire biometric characteristic information of a user; a card information determination module configured to determine card information of the user according to the biometric characteristic information for feedback; and a card information feedback module configured to feed back the card information to a terminal device, so that the terminal device transmits a transaction request to an authorization server corresponding to the card information, receives a transaction authorization verification result fed back by the authorization server in response to the transaction request, and performs a transaction according to the transaction authorize verification result.

In a sixth aspect, the embodiments of the present application provides a transaction processing apparatus. The apparatus includes: a transaction request acquisition module configured to acquire a transaction request, wherein the transaction request includes biometric characteristic information of a user and a transaction authorization verification mode depending on the biometric characteristic information; a biometric characteristic information acquisition module configured to acquire, from a biometric information server, registered biometric characteristic information of the user required by the transaction authorization verification mode; an authorization verification module configured to perform authorization verification on a transaction corresponding to the transaction request according to the registered biometric characteristic information and the biometric characteristic information included in the transaction request to obtain a transaction authorization verification result; and an authorization verification result transmission module configured to feed back the transaction authorization verification result to a terminal device that transmits the transaction request, so that the terminal device performs the transaction according to the transaction authorization verification result.

In a seventh aspect, the embodiments of the present application provides a transaction processing device. The device includes: a processor, a memory, and computer programs stored on the memory and executable on the processor, wherein the computer programs are executed by the processor to perform steps of the transaction processing method according to embodiments of the present application.

In an eighth aspect, the embodiments of the present application provides a computer-readable storage medium. The computer-readable storage medium has computer programs stored thereon, and wherein the computer programs are executed by a processor to perform steps of the transaction processing according to embodiments of the present application.

In a ninth aspect, the embodiments of the present application provides a transaction processing system. The system includes: a target biometric information server and a plurality of authorization servers, wherein the target biometric information server is configured to acquire biometric characteristic information of a user; determine card information of the user according to the biometric characteristic information for feedback; feed back the card information to a terminal device; and transmit registered biometric characteristic information of the user required by a transaction authentication verification mode to an authentication server; and the authorization server is configured to acquire a transaction request, wherein the transaction request includes the biometric characteristic information of the user and the transaction authorization verification mode depending on the biometric characteristic information; acquire, from the target biometric information server, the registered biometric characteristic information of the user required by the transaction authorization verification mode; perform authorization verification on a transaction corresponding to the transaction request according to the registered biometric characteristic information and the biometric characteristic information included in the transaction request to obtain a transaction authorization verification result; and feedback the transaction authorization verification result to the terminal device that transmits the transaction request, so that the terminal device performs the transaction according to the transaction authorization verification result.

According to the transaction processing method, apparatus, device, medium and system of the embodiments of the present application, a terminal device transmits acquired biometric characteristic information of a user to a target biometric information server; the target biometric information server determines card information of the user for feedback, and feeds back the determined card information to the terminal device; the terminal device transmits a transaction request to an authorization server; the authorization server performs authorization verification on a transaction corresponding to the transaction request, and feeds back a transaction authorization verification result to the terminal device; and the terminal device performs the transaction according to the transaction authorization verification result. Due to the authorization verification performed by the authorization server on the transaction corresponding to the transaction request, security of the user's funds can be improved.

### BRIEF DESCRIPTION OF THE DRAWINGS

In order to describe technical solutions of the embodiments of the present application more clearly, drawings that are used in the embodiments of the present application will be briefly described. For those skilled in the art, other drawings can be obtained from these drawings without requiring inventive efforts.

FIG. 1 shows a schematic structural diagram of a transaction processing system according to an embodiment of the present application;

FIG. 2 shows a schematic diagram of an architecture regarding registration of a user based on facial information according to an embodiment of the present application;

FIG. 3 shows a diagram of an overall architecture regarding a transaction procedure based on facial information according to an embodiment of the present application;

FIG. 4 shows a schematic flowchart of a transaction processing method applied to a terminal device according to an embodiment of the present application;

FIG. 5 shows a schematic flowchart of a transaction processing method applied to a target biometric information server according to an embodiment of the present application;

FIG. 6 shows a schematic flowchart of a transaction processing method applied to an authorization server according to an embodiment of the present application;

FIG. 7 shows a schematic structural diagram of a transaction processing apparatus applied to a terminal device according to an embodiment of the present application;

FIG. 8 shows a schematic structural diagram of a transaction processing apparatus applied to a target biometric information server according to an embodiment of the present application;

FIG. 9 shows a schematic structural diagram of a transaction processing apparatus applied to an authorization server according to an embodiment of the present application; and

FIG. 10 shows a structural diagram of an exemplary hardware architecture of a computing device capable of implementing the transaction processing methods and apparatuses according to the embodiments of the present application.

### DETAILED DESCRIPTION

The implementation of the present application will be described in further detail below in conjunction with the accompanying drawings and embodiments. The drawings and detailed description of the embodiments hereinafter are used to exemplarily illustrate principle of the application, rather than limit scope of the application. That is, the application is not limited to the described embodiments.

In order to solve the problem in the related art, the embodiments of the present application provide a transaction processing method, apparatus, device, medium and system that can improve security of a user's funds. The following first describes a transaction processing system according to an embodiment of the present application.

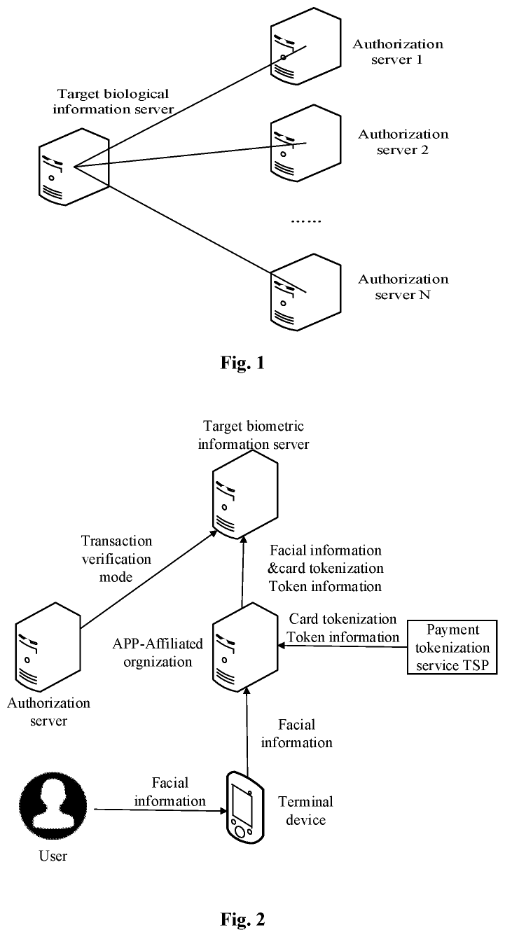

As shown in FIG. 1, it shows a schematic structural diagram of a transaction processing system according to an embodiment of the present application. The transaction processing system includes: a target biometric information server and a plurality of authorization servers.

The target biometric information server is configured to: acquire biometric characteristic information of a user; determine card information of the user back according to the biometric characteristic information for feedback; feed back the card information to a terminal device; and transmits registered biometric characteristic information of the user required by a transaction authentication verification mode to an authentication server.

The authorization server is configured to: acquire a transaction request, wherein the transaction request includes the biometric characteristic information of the user and the transaction authorization verification mode depending on the biometric characteristic information; acquire, from the target biometric information server, the registered biometric characteristic information of the user required by the transaction authorization verification mode; perform authorization verification on a transaction corresponding to the transaction request according to the registered biometric characteristic information and the biometric characteristic information included in the transaction request to obtain a transaction authorization verification result; and feed back the transaction authorization verification result to the terminal device that transmits the transaction request, so that the terminal device performs the transaction according to the transaction authorization verification result.

According to the transaction processing system according to the embodiment of the present application, due to the authorization verification performed by the authorization server on the transaction corresponding to the transaction request, security of the user's funds can be improved.

Generally, the transaction request includes information of both parties of the transaction and information of transaction amount. Thus, the authorization server can also grasp flow of the user's funds and implement supervision of the user's funds.

FIG. 1 shows N authorization servers, which are authorization server 1, authorization server 2, . . . , and authorization server N, respectively. In the case where a transaction is performed based on a bank card, the N authorization servers may be servers of different banks. For example, the authorization server 1 is a server of Merchant Bank, the authorization server 2 is a server of Construction Bank, and the authorization server N is a server of Agricultural Bank.

The biometric characteristic information in the embodiment of the present application may include one or more of the following items: facial information, fingerprint information, voiceprint information, iris information and palmprint information.

The following describes a transaction procedure by taking the facial information being the biometric characteristic information as an example.

A terminal device acquires facial information of a user, and transmits acquired facial information to the target biometric information server.

The target biometric information server determines card information of the user according to received facial information for feedback.

In an embodiment of the present application, the card information of the user determined by the target biometric information server for feedback may be only one piece, and it may be assumed that the card information is information of a card from Construction Bank. In this case, the terminal device transmits a transaction request to a server of Construction Bank. The server of Construction Bank performs authorization verification on a transaction corresponding to the transaction request, and feeds back a transaction authorization verification result to the terminal device. The terminal device conducts the transaction according to the transaction authorization verification result.

In an embodiment of the present application, the card information of the user determined by the target biometric information server for feedback may be more than one piece, and it may be assumed that the determined card information are information of a card from Construction Bank, a card from a Merchant bank, and a card from Agricultural bank. The target biometric information server feeds back the determined card information (the information of a card from Construction Bank, a card from a Merchant bank, and a card from Agricultural bank) to the terminal device. At this point, the terminal device can transmit a transaction request to an authorization server corresponding to default card information. In the case where the default card information is the information of the card from Merchant Bank, the terminal device transmits the transaction request to a server of Merchant Bank. The server of Merchant Bank performs authorization verification on a transaction corresponding to the transaction request, and feeds back a transaction authorization verification result to the terminal device. The terminal device conducts the transaction according to the transaction authorization verification result.

In an embodiment of the present application, the card information of the user determined by the target biometric information server for feedback may be more than one piece, and it may be assumed that the determined card information are information of a card from Construction Bank, a card from a Merchant bank, and a card from Agricultural bank. The target biometric information server feeds back the determined card information (the information of a card from Construction Bank, a card from a Merchant bank, and a card from Agricultural bank) to the terminal device. At this point, the user can select a bank card to be used for a transaction. In the case where the bank card selected by the user for the transaction is a bank card from Agricultural Bank, the terminal device can transmit a transaction request to a server of Agricultural Bank. The server of Agricultural Bank performs authorization verification on the transaction corresponding to the transaction request, and feeds back a transaction authorization verification result to the terminal device. The terminal device conducts the transaction according to the transaction authorization verification result.

When the card information of the user determined by the target biometric information server for feedback is more than one piece, the terminal device transmits a transaction request to an authorization server corresponding to card information selected by the user from the card information fed back from the target biometric information server.

It should be understood that a bank card from Bank X is issued by Bank X, information of the bank card from Bank X corresponds to a server of Bank X, and a transaction based on the bank card from Bank X requires authorization by the server of Bank X.

It should be also understood that in order to determine by the target biometric information server the card information of the user for feedback according to received biometric characteristic information, the biometric characteristic information of the user and the card information of the user should be stored and an association relationship therebetween should be established in advance. When determining the card information of the user for feedback, card information having an association relationship with the cacquired biometric characteristic information may be determined as the card information of the user for feedback. It should be further understood that the card information of the user may be only one piece or more than one piece.

Specifically, registered biometric characteristic information matching the acquired biometric characteristic information can be retrieved, and card information having an association relationship with the retrieved registered biometric characteristic information is determined as the card information of the user for feedback.

In an embodiment of the present application, the user can get registration through a card issuing bank application (Application Program, APP), a transaction clearing agency APP, or a third-party APP. During the registration, the biometric characteristic information of the user is acquired.

In the case where the user conducts a registration through a card issuing bank APP or a transaction clearing agency APP, the target biometric information server can directly obtain bank card information of the user, and then establish an association relationship between the biometric characteristic information and the bank card information of the user.

In the case where a user conducts a registration through a third-party APP, it may be that the user enters bank card information. After obtaining the biometric characteristic information and the bank card information of the user, the target biometric information server performs verification on the bank card information to determine whether the bank card information corresponds to the user, that is, to determine whether an owner of a bank card corresponding to the bank card information is the user. After verifying that the bank card information corresponds to the user, an association relationship between the biometric characteristic information and the bank card information of the user is established.

In the case where a user conducts a registration through a third-party APP, it may be that the target biometric information server transmits the user's identification number or mobile phone number to an authorization server, which retrieves bank card information corresponding to the user's identification number or mobile phone number and feeds back the bank card information to the target biometric information server, so that the target biometric information server establishes an association relationship between the biometric characteristic information and the bank card information of the user. It should be understood that when a user has a bank card activated, identification number and mobile phone number of the user is registered, so bank card information of the user can be retrieved via the identification number and mobile phone number registered when the user has the bank card activated.

In an embodiment of the present application, the card information may be original card information that has not been subjected to a tokenization process.

In an embodiment of the present application, in order to prevent the user's card information from leaking, the card information may be subjected to a tokenization processing to generate card tokenization Token information. In an embodiment of the present application, the card tokenization Token information may be generated using a payment tokenization service (Token Service Provider, TSP). The payment tokenization service TSP is a basic security service for digital payment, which can be used to provide security for payment in banks, payment institutions and industry institutions. The payment tokenization service TSP uses a particular payment tokenization Token to replace a traditional bank card number, which effectively reduces risks of card information leakage at a merchant side or an acceptance institution side, and reduces fraudulent transactions. The target biometric information server may retrieve bank card tokenization Token information corresponding to bank card information of the user according to biometric characteristic information of the user, and then feeds back the retrieved bank card tokenization Token information corresponding to the bank card information of the user to the terminal device. Exemplarily, the bank card tokenization Token information may include: bank information and information of a part of a bank card number. For example, the bank card tokenization Token information includes: Construction Bank, 6666 **** **** 1234, where the symbols * therein denote a part of the bank card number.

In an embodiment of the present application, in order for the target biometric information server to retrieve the bank card tokenization Token information corresponding to the bank card information of the user according to received biometric characteristic information, biometric characteristic information of the user and the bank card tokenization Token information of the user should be stored and an association relationship therebetween should be established in advance.

In an embodiment of the present application, a user can get registration through a card issuing bank APP, a transaction clearing agency (card organization) APP, or a third-party APP. During the registration, biometric characteristic information of the user is acquired.

In the case where a user conducts a registration through a card issuing bank APP or a transaction clearing agency APP, the target biometric information server can directly obtain bank card information of the user, generates bank card tokenization Token information corresponding to the bank card information of the user by using the payment tokenization service TSP, and then establish an association relationship between the biometric characteristic information and bank card tokenization Token information corresponding to the bank card information of the user.

In the case where a user conducts a registration through a third-party APP, it may be that the user enters bank card information. After acquiring biometric characteristic information and the bank card information of the user, the target biometric information server performs verification on the bank card information to determine whether the bank card information corresponds to the user, that is, to determine whether an owner of a bank card corresponding to the bank card information is the user. After verifying that the bank card information corresponds to the user, bank card tokenization Token information corresponding to the bank card information of the user is generated by using the payment tokenization service TSP, and then an association relationship between biometric characteristic information and bank card tokenization Token information corresponding to the bank card information of the user is established.

In the case where a user conducts a registration through a third-party APP, it may be that the target biometric information server transmits the user's identification number or mobile phone number to an authorization server, which retrieves bank card information corresponding to the user's identification number or mobile phone number and feeds back the bank card information to the target biometric information server, so that the target biometric information server generates bank card tokenization Token information corresponding to the bank card information of the user and then establishes an association relationship between biometric characteristic information and the bank card tokenization Token information corresponding to the bank card information of the user. It should be understood that when a user has a bank card activated, identification number and mobile phone number of the user is registered, so bank card information of the user can be retrieved via the identification number and mobile phone number registered when the user has the bank card activated.

According to the embodiment of the present application, the target biometric information server can feed back the bank card tokenization Token information corresponding to the bank card information associated with the user to the terminal device, which can prevent the user's card information from leaking and thereby security of the user's funds can be improved.

In an embodiment of the present application, after retrieving bank card information associated with the user based on received biometric characteristic information, the target biometric information server may generate a temporary bank card tokenization Token information corresponding to the bank card information of the user by using payment tokenization service TSP, and feeds back the temporary bank card tokenization Token information to the terminal device. The temporary bank card tokenization Token information is only valid for a period of time, such as 3 minutes.

According to the embodiment of the present application, the temporary bank card tokenization Token information is used, which can prevent the card information of the user from leaking and thereby security of the user's funds can be improved.

In an embodiment of the present application, the authorization server performs verification on a transaction by using a transaction authorization verification mode. For example, Construction Bank requires a short message verification code received by a mobile phone number registered when a bank card is activated or a transaction password of a bank card; Merchant Bank requires a transaction password of a bank card or biometric characteristic information (such as facial information, fingerprint information, or the like) of a user; Agricultural Bank requires a short message verification code received by a mobile phone number registered when a bank card is activated or biometric characteristic information (such as facial information, fingerprint information, etc.) of a user. In view of this, the terminal device may also transmit transaction verification capability supported by the terminal device to the target biometric information server. The target biometric information server determines the card information of the user for feedback according to the transaction verification capability and a transaction authorization verification mode required by the authorization server, and then feeds back card information that is associated with the user and meets the transaction verification capability supported by the terminal device to the terminal device.

Exemplarily, it is supposed that a user has three bank cards, i.e. a bank card from Construction Bank, a bank card from Merchant Bank, and a bank card from Agricultural Bank. The transaction authorization verification mode required by Construction Bank is a verification via a short message verification code or a fingerprint verification; the transaction authorization verification mode required by Merchant Bank is a face verification or a verification via a short message verification code; the transaction authorization verification mode of Agricultural Bank is a face verification or a fingerprint verification. The terminal device has a camera, but does not have a fingerprint collector, that is, the terminal device has capability of performing a face verification rather than a fingerprint verification. Then, the target biometric information server determines the bank card information of the user for feedback as: information of a back card from Merchants Bank and information of a bank card of Agricultural Bank, according to the transaction verification capability supported by the terminal device and the transaction authorization verification mode required by the authorization servers.

In an embodiment of the present application, each of the authorization servers may have their required transaction authorization verification modes stored in the target biometric information server.

In an embodiment of the present application, there may be multiple transaction authorization verification modes required by an authorization server, and the authorization server may also transmit priority information of the transaction authorization verification modes to the target biometric information server for storage, the priority information may be: face verification has a higher priority than a fingerprint verification, fingerprint verification has a higher priority than a verification via mobile phone verification code, or a verification via a mobile phone verification code has a higher priority than a verification via a payment password, etc.

In an embodiment of the present application, the terminal device may also transmit the identification information of the user to the target biometric information server, and the target biometric information server retrieves registered biometric characteristic information corresponding to the identification information, determines whether received biometric characteristic information and the retrieved registered biometric characteristic information refer to a same user, and in the case where the received biometric characteristic information and the retrieved registered biometric characteristic information refer to the same user, card information corresponding to the retrieved registered biometric characteristic information is determined as the card information of the user for feedback.

Compared with biometric characteristic information matching, the identification information of the user can be used to quickly retrieve biometric characteristic information corresponding to the identification information of the user, so that it is sufficient to perform a matching between the captured biometric characteristic information and biometric characteristic information corresponding to the retrieved user's identification information, and thus there is no need to use the biometric characteristic information to be matched with multiple pre-registered biometric characteristic information one by one, which can increase speed of determination of the card information, thereby improving transaction processing efficiency.

In an embodiment of the present application, the terminal device may also perform bioassay on the user. The bioassay is used to determine whether the acquired biometric characteristic information comes from a living body. During the bioassay, the user may be required to blink, turn his head, open his mouth, and so on.

Through bioassay, it can prevent others from using the user's photos to consume with the user's bank card, and thereby security of the user's funds can be improved.

In an embodiment of the present application, some functions of the target biometric information server may be implemented by another server (such as an intermediate biometric information server), such as the function of retrieving registered biometric characteristic information matching the captured biometric characteristic information. In view of this, the terminal device may transmit the biometric characteristic information to the intermediate biometric information server, and the intermediate biometric information server retrieve registered biometric characteristic information matching the captured biometric characteristic information, and then transmits identity information corresponding to the retrieved registered biometric characteristic information to the target biometric information server. The target biometric information server determines the card information of the user for feedback according to the received identity information. In an embodiment of the present application, the identity information includes but is not limited to: the user's mobile phone number, the user's identification number, etc.

In an embodiment of the present application, the intermediate biometric information server may be implemented by a transaction clearing institution or a third-party company, or by a merchant or a payment service provider or gateway company that serves it. The target biometric information server may be implemented by the transaction clearing agency.

After receiving a transaction request sent by the terminal device including the biometric characteristic information of the user and the transaction authorization verification mode depending on the biometric characteristic information, the authorization server acquires, from the target biometric information server, registered biometric characteristic information of the user required by the transaction authorization verification mode; performs authorization verification on the transaction corresponding to the transaction request according to the registered biometric characteristic information and the biometric characteristic information included in the transaction request to obtain a transaction authorization verification result; and feeds back the transaction authorization verification result to the terminal device that transmits the transaction request. The terminal device performs the transaction according to the transaction authorization verification result.

Exemplarily, it is supposed that the terminal device A initiates a transaction request to an authorization server, and the transaction request includes facial information a of a user X and a transaction authorization verification mode required for authorization verification via the facial information. It should be understood that the transaction request may also include card information for the transaction. The authorization server acquires registered facial information b corresponding to the card information from the target biometric information server; uses the registered facial information b and the facial information a to perform authorization on the transaction. If the facial information b and facial information a refer to facial information of a same user, the authorization succeeds; but if the facial information b and the facial information a refer to facial information of different users, the authorization fails. The terminal device performs the transaction according to a transaction authorization verification result.

FIG. 2 shows a schematic diagram of an architecture regarding registration of a user based on facial information according to an embodiment of the present application.

A user chooses to register on an APP (card issuing bank APP, transaction clearing institution APP or third-party APP) of a terminal device. The terminal device acquires facial information of the user and uploads the acquired facial information to an APP-affiliated organization.

The APP-affiliated organization acquires card tokenization Token information corresponding to the user from a payment tokenization service TSP, and transmits the facial information of the user and the card tokenization Token information corresponding to the user to a target biometric information server.

The target biometric information server stores the facial information and the card tokenization Token information of the user, and establishes an association relationship between the facial information and the card tokenization Token information of the user.

An authorization server transmits its required transaction authorization verification mode to the target biometric information server.

The target biometric information server stores the transaction authorization verification mode required by the authorization server.

In the embodiment of the present application, the terminal device used by the user for registration include, but is not limited to, a mobile phone, a tablet computer, a notebook computer, a palmtop computer, and a vehicle-mounted terminal.

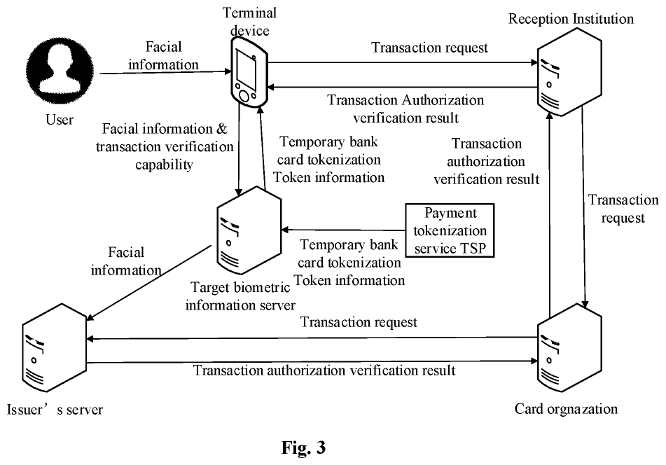

FIG. 3 shows a diagram of an overall architecture regarding a transaction procedure based on facial information according to an embodiment of the present application.

A terminal device captures facial information of a user, transmits the facial information of the user to the target biometric information server, and transmits transaction verification capability supported by the terminal device to the target biometric information server.

The target biometric information server determines bank card information of the user for feedback based on the received facial information, transaction verification capability supported by the terminal device and a transaction authorization verification mode required by an authorization server, and acquires temporary bank card tokenization Token information corresponding to each piece of the bank card information from a payment tokenization service TSP, and feeds back the temporary bank card tokenization Token information to the terminal device.

The terminal device displays the temporary bank card tokenization Token information. The user selects a bank card and a transaction authorization verification mode for a transaction based on the displayed temporary bank card tokenization Token information. It is assumed that the transaction authorization verification mode selected by the user is face verification. The terminal device transmits a transaction request to an authorization server through an acquiring institution and a card organization, wherein transaction request includes the temporary bank card tokenization Token information, the facial information, and the face verification mode.

The authorization server acquires registered facial information corresponding to the temporary bank card tokenization Token information from the target biometric information server, and then performs authorization on the transaction based on the acquired facial information. When the authorization verification is successful, a transaction authorization verification result corresponding to the successful authorization verification is fed back to the terminal device through the card organization and the acquiring institution. The terminal device performs the transaction according to the transaction authorization verification result corresponding to the successful authorization verification. When the authorization verification fails, a transaction authorization verification result corresponding to failed authorization verification is fed back to the terminal device through the card organization and the acquiring institution. The terminal device stops the transaction according to the transaction authorization verification result corresponding to the failed authorization verification.

In the embodiment of the present application, the terminal device used by the user for transaction include, but is not limited to, a mobile phone, a tablet computer, a notebook computer, a palmtop computer, an offline merchant equipment, and an automatic teller machine (Automatic Teller Machine, ATM).

The transaction in the embodiment of the application includes, but is not limited to, offline payment to a merchant, online payment to a merchant, ATM withdrawal, online transfer and ATM transfer.

In the scenario where a user pays to a merchant offline, if the user makes a payment to the merchant for the first time, the user is required to enter a mobile phone number, and the terminal device captures facial information of the user and performs a bioassay of the user. The terminal device uploads the user's mobile phone number, facial information and transaction verification capability supported by the terminal device to the target biometric information server. The target biometric information server determines bank card information of the user for feedback based on the facial information and the transaction verification capability supported by the terminal device.

If a time period from the user's last payment to the merchant to the current time does not exceed a certain time (such as one month), the user does not need to enter the mobile phone number, but the terminal device captures facial information of the user and performs a bioassay of the user. The terminal device uploads the facial information and transaction verification capability supported by the terminal device to the target biometric information server. The target biometric information server determines bank card information of the user for feedback based on the facial information and the transaction verification capability supported by the terminal device.

If the time period from the user's last payment to the merchant to the current time exceeds a certain time (such as one month) or the number of payments to the merchant exceeds a certain number (such as 5000), the user needs to re-enter the mobile phone number, and terminal equipment captures facial information of the user and performs a bioassay of the user. The terminal device uploads the user's mobile phone number, facial information and transaction verification capability supported by the terminal device to the target biometric information server. The target biometric information server determines bank card information of the user for feedback based on the facial information and the transaction verification capability supported by the terminal device.

The target biometric information server returns the determined bank card information of the user for feedback to the terminal device.

The terminal device transmits a transaction request to an authorization server, which may be an authorization server corresponding to a bank card selected by the user for transaction. The transaction request may include bioassay results, face verification mode and the facial information of the user.

The authorization server acquires the facial information of the user from the target biometric information server based on the face verification mode, and decides, based on the facial information of the user obtained from the target biometric information server and the facial information of the user included in the transaction request as well as the bioassay result included in the transaction request, whether to perform an authorization verification on the transaction corresponding to the transaction request, and feedbacks an authorization verification result to the terminal device.

The terminal device conducts the transaction according to the transaction authorization verification result.

In an embodiment of the present application, if a merchant is on duty when the user is paying to the merchant offline, the bioassay step can be skipped after the consent of the merchant.

In the scenario where a user makes an online payment to a merchant or transfers money online, the terminal device performs bioassay of the user and captures facial information of the user, and uploads a terminal device number, the facial information and transaction verification capability supported by the terminal device to the target biometric information server. The target biometric information server detects bank card information of the user in a facial information database corresponding to the terminal device number. If the bank card information of the user is not retrieved, the user is required to enter a mobile phone number. The target biometric information server determines the bank card information of the user for feedback based on the facial information and the transaction verification capability supported by the terminal device.

The target biometric information server returns the determined bank card information of the user for feedback to the terminal device.

The terminal device transmits a transaction request to a authorization server, which may be an authorization server corresponding to a bank card selected by the user for transaction. The transaction request may include bioassay results, the facial verification mode and the facial information of the user.

The authorization server acquires the facial information of the user from the target biometric information server based on the face verification mode, and decides, based on the facial information of the user obtained from the target biometric information server and the facical information of the user included in the transaction request as well as the bioassay results included in the transaction request, whether to perform authorization verification on the transaction corresponding to the transaction request, and feedbacks the authorization verification result to the terminal device.

The terminal device conducts the transaction according to the transaction authorization verification result.

In the scenario of withdrawal and transfer via an ATM, the ATM captures facial information of a user and performs bioassay on the user. The ATM uploads the facial information to the target biometric information server. The target biometric information server determines bank card information of the user for feedback based on the facial information.

The target biometric information server returns the determined bank card information of the user for feedback to the ATM.

The ATM transmits a transaction request to a authorization server, which may be an authorization server corresponding to a bank card selected by the user for transaction. The transaction request may include bioassay results, the facial verification mode and the facial information of the user.

The authorization server acquires the facial information of the user from the target biometric information server based on the face verification mode, and decides, based on the facial information of the user obtained from the target biometric information server and the facial information of the user included in the transaction request as well as the bioassay results included in the transaction request, whether to perform authorization verification on the transaction corresponding to the transaction request, and feedbacks the authorization verification result to the ATM.

The ATM conducts the transaction according to the transaction authorization verification result.

In an embodiment of the present application, after the target biometric information server returns the determined bank card information of the user for feedback to the ATM, the user can select the bank card for transaction. After the bank card is selected, the user can directly enter a transaction password of the bank card. The ATM transmits the transaction request containing the transaction password and the bioassary results to the authorization server corresponding to the bank card selected by the user for transaction.

The authorization server corresponding to the bank card selected by the user for transaction determines whether to perform authorization verification on the transaction (withdrawal transaction or transfer transaction) corresponding to the transaction request based on the bioassary results and a transaction password verification result, and feeds back a authorization verification result to the terminal device.

The ATM conducts the transaction according to the transaction authorization verification result.

In an embodiment of the present application, the aforementioned target biometric information server may include: a first server and a second server.

The first server may be responsible for storage of biometric characteristic information and retrieval of card information. The second server may be responsible for application and management of a user account, routing of biometric characteristic information, and management of and retrieving verification elements of an issuing bank.

Specifically, the terminal device captures facial information of a user, and uploads the facial information of the and transaction verification capability supported by the terminal device to the first server. The first server retrieves identity information of the user according to the facial information, and uploads the identity information of the user and the transaction verification capability supported by the terminal device to the second server. The second server determines bank card information of the user for feedback according to the identity information of the user, the transaction verification capability supported by the terminal device and a transaction authorization verification mode required by the issuing bank, acquires bank card Token information corresponding to the determined bank card information, and returns it to the terminal device through the first server. The terminal device initiates a transaction request to a authorization server, wherein the transaction request includes a face verification mode. The authorization server acquire the facial information from the first server, performs authorization verification on the transaction corresponding to the transaction request based on the acquired facial information, and then feeds back an authorization verification result to the terminal device. The terminal device conducts the transaction according to the transaction authorization verification result.

It should be noted that the above embodiments are described by taking the facial information as an example, but it is only a specific example of the present application and does not constitute a limitation to the present application.

It should be noted that the above embodiments are described by taking the bank card as an example, but it is only a specific example of the present application and does not constitute a limitation to the present application. In an embodiment of the present application, the card may be a transportation card (bus card) or a membership card with payment function.

The target biometric information server in the embodiments of the present application may be a biometric payment service provider (Bio-payment Service Provider, BPSP).

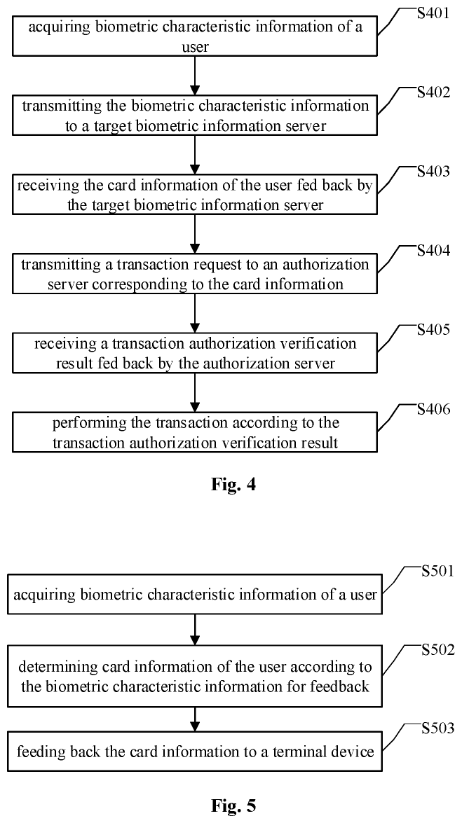

Based on the foregoing, an embodiment of the present application provides a transaction processing method applied to a terminal device, as shown in FIG. 4. FIG. 4 shows a schematic flowchart of a transaction processing method applied to a terminal device according to an embodiment of the present application. The transaction processing method applied to the terminal device includes:

S401: capturing biometric characteristic information of a user;

S402: transmitting the biometric characteristic information to a target biometric information server, so that the target biometric information server determines card information of the user according to the biometric characteristic information for feedback;

S403: receiving the card information of the user fed back by the target biometric information server;

S404: transmitting a transaction request to an authorization server corresponding to the card information, so that the authorization server performs authorization verification on a transaction corresponding to the transaction request;

S405: receiving a transaction authorization verification result fed back by the authorization server; and

S406: performing the transaction according to the transaction authorization verification result.

In an embodiment of the present application, the biometric characteristic information in the embodiment of the present application may include one or more of the following items: facial information, fingerprint information, voiceprint information, iris information and palmprint information.

The following describes the transaction processing method applied to a terminal device by taking the biometric characteristic information being facial information as an example.

The terminal device captures facial information of a user, and transmits the captured facial information to a target biometric information server.

The target biometric information server receives the facial information sent by the terminal device; and determines card information of the user for feedback according to the received facial information.

In an embodiment of the present application, the card information of the user for feedback determined by the target biometric information server may be only one piece, and it is assumed that the card information is information of a card from Construction Bank. In this case, the terminal device transmits a transaction request to a server of Construction Bank. The server of Construction Bank performs authorization verification on a transaction corresponding to the transaction request, and feeds back a transaction authorization verification result to the terminal device. The terminal device performs the transaction according to the transaction authorization verification result.

In an embodiment of the present application, the card information of the user for feedback determined by the target biometric information server may be more than one piece, and it is assumed that the determined card information are information of a card from Construction Bank, a card from a Merchant bank, and a card from Agricultural bank. The target biometric information server feeds back the determined card information (the information of a card from Construction Bank, a card from a Merchant bank, and a card from Agricultural bank) to the terminal device. At this point, the terminal device can transmit a transaction request to an authorization server corresponding to default card information. In the case where the default card information is the information of the card from Merchant Bank, the terminal device transmits the transaction request to a server of Merchant Bank. The server of Merchant Bank performs authorization verification on a transaction corresponding to the transaction request, and feeds back a transaction authorization verification result to the terminal device. The terminal device conducts the transaction according to the transaction authorization verification result.

In an embodiment of the present application, the card information of the user for feedback determined by the target biometric information server may be more than one piece, and it is assumed that the determined card information are information of a card from Construction Bank, a card from a Merchant bank, and a card from Agricultural bank. The target biometric information server feeds back the determined card information (the information of a card from Construction Bank, a card from a Merchant bank, and a card from Agricultural bank) to the terminal device. At this point, the user can select a bank card to be used for a transaction. In the case where the bank card selected by the user for the transaction is a bank card from Agricultural Bank, the terminal device can transmit a transaction request to a server of Agricultural Bank. The server of Agricultural Bank performs authorization verification on the transaction corresponding to the transaction request, and feeds back a transaction authorization verification result to the terminal device. The terminal device conducts the transaction according to the transaction authorization verification result.

The transaction processing method applied to a terminal device according to the embodiment of the present application can implement authorization verification by the authorization server on a transaction corresponding to a transaction request, and thus security of a user's funds can be improved.

In an embodiment of the present application, the transmitting the transaction request to the authorization server corresponding to the card information may include: transmitting the transaction request to the authorization server corresponding to card information selected by the user from the card information fed back from the target biometric information server.

The user selects a bank card for the transaction, and it is assumed that the bank card selected by the user for the transaction is a bank card from Agricultural Bank. Then the terminal device can transmit the transaction request to a server of Agricultural Bank. The server of Agricultural Bank performs authorization verification on the transaction corresponding to the transaction request, and feeds back a transaction authorization verification result to the terminal device. The terminal device conducts the transaction according to transaction authorization verification result.

In an embodiment of the present application, the transaction processing method applied to the terminal device according to the embodiment of the present application may further include: transmitting transaction verification capability supported by a terminal device that captures the biometric characteristic information to the target biometric information server, so that the target biometric information server determines the card information of the user for feedback based on the transaction verification capability and a transaction authorization verification mode required by the authorization server.

In an embodiment of the present application, the authorization server performs verification on a transaction by using a transaction authorization verification mode. For example, Construction Bank requires a short message verification code received by a mobile phone number registered when a bank card is activated or a transaction password of a bank card; Merchant Bank requires a transaction password of a bank card or biometric characteristic information (such as facial information, fingerprint information, or the like) of a user; Agricultural Bank requires a short message verification code received by a mobile phone number registered when a bank card is activated or biometric characteristic information (such as facial information, fingerprint information, etc.) of a user. In view of this, the terminal device may also transmit transaction verification capability supported by the terminal device to the target biometric information server. The target biometric information server determines card information of the user for feedback according to the transaction verification capability and a transaction authorization verification mode required by the authorization server, and then feeds back card information that is associated with the user and meets the transaction verification capability supported by the terminal device to the terminal device.

Exemplarily, it is supposed that a user has three bank cards, i.e. a bank card from Construction Bank, a bank card from Merchant Bank, and a bank card from Agricultural Bank. The transaction authorization verification mode required by Construction Bank is a verification via a short message verification code or a fingerprint verification; the transaction authorization verification mode required by Merchant Bank is a face verification or a verification via a short message verification code; the transaction authorization verification mode of Agricultural Bank is a face verification or a fingerprint verification. The terminal device has a camera, but does not have a fingerprint collector, that is, the terminal device has capability of performing a face verification rather than a fingerprint verification. Then, the target biometric information server determines the bank card information of the user for feedback as: information of a back card from Merchants Bank and information of a bank card of Agricultural Bank, according to the transaction verification capability supported by the terminal device and the transaction authorization verification mode required by the authorization servers.

In an embodiment of the present application, the transaction processing method applied to the terminal device according to the embodiment of the present application may further include: transmitting identification information of the user to the target biometric information server, so that the target biometric information server retrieves registered biometric characteristic information corresponding to the identification information, determines whether the received biometric characteristic information and the retrieved registered biometric characteristic information refer to the same user, and determines card information corresponding to the retrieved registered biometric characteristic information as the card information of the user for feedback when the received biometric characteristic information and the retrieved registered biometric characteristic information refer to the same user.

Compared with biometric information matching, the user's identification information can be used to quickly retrieve biometric characteristic information corresponding to the user's identification information, so that it is sufficient to perform a matching between the captured biometric characteristic information and biometric characteristic information corresponding to the retrieved user's identification information, and thus there is no need to use the biometric characteristic information to be matched with multiple pre-registered biometric characteristic information one by one, which can increase speed of determination of the card information, thereby improving transaction processing efficiency.

In an embodiment of the present application, the transaction processing method applied to the terminal device according to the embodiment of the present application may further include: performing bioassay on the user, wherein the transaction request comprises bioassay results.

The bioassay is used to determine whether the captured biometric characteristic information comes from a living body. During the bioassay, the user may be required to blink, turn his head, open his mouth, and so on.

Through the bioassay, it can prevent others from using the user's photos to consume with the user's bank card, and thus security of the user's funds can be improved.

In an embodiment of the present application, the transmitting the biometric characteristic information to the target biometric information server may include: transmitting the biometric characteristic information to an intermediate biometric information server, so that the intermediate biometric information server retrieves registered biometric characteristic information matching the biometric characteristic information and transmits identity information corresponding to the retrieved registered biometric characteristic information to the target biometric information server, such that the target biometric information server determines the card information of the user for feedback according to the received identity information.

In an embodiment of the present application, some functions of the target biometric information server may be implemented by another server (such as an intermediate biometric information server), such as the function of retrieving registered biometric characteristic information matching the captured biometric characteristic information. In view of this, the terminal device may transmit the biometric characteristic information to the intermediate biometric information server, and the intermediate biometric information server retrieve registered biometric characteristic information matching the captured biometric characteristic information, and then transmits identity information corresponding to the retrieved registered biometric characteristic information to the target biometric information server. The target biometric information server determines the card information of the user for feedback according to the received identity information.

In an embodiment of the present application, the aforementioned card information may be original card information that has not been subject to a tokenization processing.

In an embodiment of the present application, in order to prevent the card information of the user from leaking, the card information may be subjected to a tokenization processing to generate card tokenization Token information.

According to the embodiment of the present application, the target biometric information server may feed back the bank card tokenization Token information corresponding to the bank card information associated with the user to the terminal device, which can prevent the card information of the user from leaking, and thus security of the user's funds can be improved.

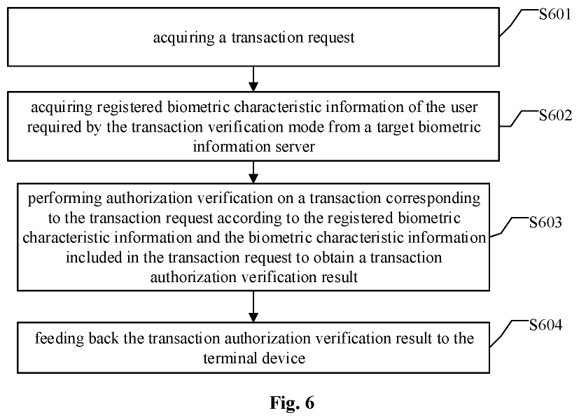

The embodiments of the present application also provides a transaction processing method applied to a target biometric information server. FIG. 5 shows a schematic flowchart of a transaction processing method applied to a target biometric information server according to an embodiment of the present application. The transaction processing method applied to a target biometric information server includes:

S501: acquiring biometric characteristic information of a user;

S502: determining card information of the user according to the biometric characteristic information for feedback; and

S503: feeding back the card information to a terminal device, so that the terminal device transmits a transaction request to an authorization server corresponding to the card information, receives a transaction authorization verification result fed back by the authorization server in response to the transaction request and performs a transaction according to the transaction authorize verification result.

In an embodiment of the present application, the biometric characteristic information includes one or more of the following items: facial information, fingerprint information, voiceprint information, iris information and palmprint information.

The following describes the transaction processing method applied to a terminal device target biometric information server by taking the biometric characteristic information being facial information as an example.

The terminal device captures facial information of a user, and transmits the captured facial information to a target biometric information server.

The target biometric information server receives the facial information sent by the terminal device; and determines card information of the user for feedback according to the received facial information.

It should be also understood that in order to determine by the target biometric information server card information of a user for feedback according to received biometric characteristic information, biometric characteristic information of the user and card information of the user should be stored and an association relationship therebetween should be established in advance. It should be also understood that the card information of the user may be only one piece or more than one piece. In view of this, the transaction processing method applied to the target biometric information server according to the embodiment of the present application may further include: acquiring biometric characteristic information of the user for registration and one or more pieces of card information of the user; and establishing an association relationship between the biometric characteristic information of the user for registration and the one or more pieces of card information of the user.

Then, when determining the card information of the user for feedback, card information associated with the registered biometric characteristic information that matches with the biometric characteristic information can be determined as the card information of the user for feedback.

In an embodiment of the present application, a user can get registration through a card issuing bank application, a transaction clearing agency APP, or a third-party APP. During the registration, biometric characteristic information of the user is acquired.

In the case where a user conducts a registration through a card issuing bank APP or a transaction clearing agency APP, the target biometric information server can directly obtain bank card information of the user, and then establish an association relationship between biometric characteristic information and bank card information of the user.

In the case where a user conducts a registration through a third-party APP, it may be that the user enters bank card information. After obtaining biometric characteristic information and the bank card information of the user, the target biometric information server performs verification on the bank card information to determine whether the bank card information corresponds to the user, that is, to determine whether an owner of a bank card corresponding to the bank card information is the user. After verifying that the bank card information corresponds to the user, an association relationship between biometric characteristic information and the bank card information of the user is established.

In the case where a user conducts a registration through a third-party APP, it may be that the target biometric information server transmits the user's identification number or mobile phone number to an authorization server, which retrieves bank card information corresponding to the user's identification number or mobile phone number and feeds back the bank card information to the target biometric information server, so that the target biometric information server establishes an association relationship between biometric characteristic information and bank card information of the user. It should be understood that when a user has a bank card activated, identification number and mobile phone number of the user is registered, so bank card information of the user can be retrieved via the identification number and mobile phone number registered when the user has the bank card activated.

In an embodiment of the present application, the transaction processing method applied to the target biometric information server according to the embodiment of the present application may further include: acquiring transaction verification capability supported by the terminal device. The determining the card information of the user for feedback according to the biometric characteristic information may include: determining the card information of the user for feedback according to the biometric characteristic information, the transaction verification capability and a transaction authorization verification mode required by the authorization server.

In an embodiment of the present application, the authorization server performs verification on a transaction by using a transaction authorization verification mode. For example, Construction Bank requires a short message verification code received by a mobile phone number registered when a bank card is activated or a transaction password of a bank card; Merchant Bank requires a transaction password of a bank card or biometric characteristic information (such as facial information, fingerprint information, or the like) of a user; Agricultural Bank requires a short message verification code received by a mobile phone number registered when a bank card is activated or biometric characteristic information (such as facial information, fingerprint information, etc.) of a user. In view of this, the terminal device may also transmit transaction verification capability supported by the terminal device to the target biometric information server. The target biometric information server determines the card information of the user for feedback according to the transaction verification capability and a transaction authorization verification mode required by the authorization server, and then feeds back card information that is associated with the user and meets the transaction verification capability supported by the terminal device to the terminal device.

Exemplarily, it is supposed that a user has three bank cards, i.e. a bank card from Construction Bank, a bank card from Merchant Bank, and a bank card from Agricultural Bank. The transaction authorization verification mode required by Construction Bank is a verification via a short message verification code or a fingerprint verification; the transaction authorization verification mode required by Merchant Bank is a face verification or a verification via a short message verification code; the transaction authorization verification mode of Agricultural Bank is a face verification or a fingerprint verification. The terminal device has a camera, but does not have a fingerprint collector, that is, the terminal device has capability of performing a face verification rather than a fingerprint verification. Then, the target biometric information server determines the bank card information of the user for feedback as: information of a back card from Merchants Bank and information of a bank card of Agricultural Bank, according to the transaction verification capability supported by the terminal device and the transaction authorization verification mode required by the authorization servers.

In an embodiment of the present application, the transaction processing method applied to the target biometric information server according to the embodiment of the present application may further include: acquiring identification information of the user. The determining the card information of the user for feedback according to the biometric characteristic information may include: retrieving registered biometric characteristic information corresponding to the identification information; determining whether the received biometric characteristic information and the retrieved registered biometric characteristic information refer to the same user; and determining the card information of the user for feedback according to the retrieved registered biometric characteristic information when the received biometric characteristic information and the retrieved registered biometric characteristic information refer to the same user.

Compared with biometric characteristic information matching, the identification information of the user can be used to quickly retrieve biometric characteristic information corresponding to the user's identification information, so that it is sufficient to perform a matching between the captured biometric characteristic information and biometric characteristic information corresponding to the retrieved user's identification information, and thus there is no need to use the biometric characteristic information to be matched with multiple pre-registered biometric characteristic information one by one, which can increase speed of determination of the card information, thereby improving transaction processing efficiency.

In an embodiment of the present application, in order to prevent the card information of the user from leaking, the target biometric information server may retrieve bank card tokenization Token information corresponding to the bank card information associated with the user according to the biometric characteristic information of the user, and then feeds back the retrieved bank card tokenization Token information corresponding to the bank card information associated with the user to the terminal device.

In an embodiment of the present application, in order for the target biometric information server to retrieve the bank card tokenization Token information corresponding to the bank card information of the user according to received biometric characteristic information, biometric characteristic information of the user and the bank card tokenization Token information corresponding to bank card information associated with the user should be stored and an association relationship therebetween should be established in advance.

In an embodiment of the present application, a user can get registration through a card issuing bank APP, a transaction clearing agency (card organization) APP, or a third-party APP. During the registration, biometric characteristic information of the user is acquired.

In the case where a user conducts a registration through a card issuing bank APP or a transaction clearing agency APP, the target biometric information server can directly obtain bank card information of the user, generates bank card tokenization Token information corresponding to the bank card information of the user by using the payment tokenization service TSP, and then establish an association relationship between the biometric characteristic information and bank card tokenization Token information corresponding to the bank card information of the user.

In the case where a user conducts a registration through a third-party APP, it may be that the user enters bank card information. After acquiring biometric characteristic information and the bank card information of the user, the target biometric information server performs verification on the bank card information to determine whether the bank card information corresponds to the user, that is, to determine whether an owner of a bank card corresponding to the bank card information is the user. After verifying that the bank card information corresponds to the user, bank card tokenization Token information corresponding to the bank card information of the user is generated by using the payment tokenization service TSP, and then an association relationship between biometric characteristic information and bank card tokenization Token information corresponding to the bank card information of the user is established.

In the case where a user conducts a registration through a third-party APP, it may be that the target biometric information server transmits the user's identification number or mobile phone number to an authorization server, which retrieves bank card information corresponding to the user's identification number or mobile phone number and feeds back the bank card information to the target biometric information server, so that the target biometric information server generates bank card tokenization Token information corresponding to the bank card information of the user and then establishes an association relationship between biometric characteristic information and the bank card tokenization Token information corresponding to the bank card information of the user. It should be understood that when a user has a bank card activated, identification number and mobile phone number of the user is registered, so bank card information of the user can be retrieved via the identification number and mobile phone number registered when the user has the bank card activated.

According to the embodiment of the present application, the target biometric information server can feed back the bank card tokenization Token information corresponding to the bank card information associated with the user to the terminal device, which can prevent the card information of the user from leaking and thereby security of the user's funds can be improved.

In an embodiment of the present application, the card information may include: temporary card tokenization Token information that has been subjected to a tokenization processing.

In an embodiment of the present application, after retrieving the bank card information associated with the user based on the received biometric characterisitics information, the target biometric information server can use the payment tokenization service TSP to tokenize the bank card information to generate the temporary bank card tokenization Token information corresponding to the bank card information of the user, and feeds back it to the terminal device. The temporary bank card tokenization Token information is only valid for a period of time, such as 3 minutes.

According to the embodiment of the present application, the temporary bank card tokenization Token information is used, which can prevent the card information of the user from leaking and thereby security of the user's funds can be improved.

In an embodiment of the present application, the card information of the user for feedback determined by the target biometric information server may be only one piece, and it is assumed that the card information is information of a card from Construction Bank. In this case, the terminal device transmits a transaction request to a server of Construction Bank. The server of Construction Bank performs authorization verification on a transaction corresponding to the transaction request, and feeds back a transaction authorization verification result to the terminal device. The terminal device performs the transaction according to the transaction authorization verification result.

In an embodiment of the present application, the card information of the user for feedback determined by the target biometric information server may be more than one piece, and it is assumed that the determined card information are information of a card from Construction Bank, a card from a Merchant bank, and a card from Agricultural bank. The target biometric information server feeds back the determined card information (information of the card from Construction Bank, the card from a Merchant bank, and the card from Agricultural bank) to the terminal device. At this point, the terminal device can transmit a transaction request to an authorization server corresponding to default card information. In the case where the default card information is the information of the card from Merchant Bank, the terminal device transmits the transaction request to a server of Merchant Bank. The server of Merchant Bank performs authorization verification on a transaction corresponding to the transaction request, and feeds back a transaction authorization verification result to the terminal device. The terminal device conducts the transaction according to the transaction authorization verification result.

In an embodiment of the present application, the card information of the user for feedback determined by the target biometric information server may be more than one piece, and it is assumed that the determined card information are information of a card from Construction Bank, a card from a Merchant bank, and a card from Agricultural bank. The target biometric information server feeds back the determined card information (the information of a card from Construction Bank, a card from a Merchant bank, and a card from Agricultural bank) to the terminal device. At this point, the user can select a bank card to be used for a transaction. In the case where the bank card selected by the user for the transaction is a bank card from Agricultural Bank, the terminal device can transmit a transaction request to a server of Agricultural Bank. The server of Agricultural Bank performs authorization verification on the transaction corresponding to the transaction request, and feeds back a transaction authorization verification result to the terminal device. The terminal device conducts the transaction according to the transaction authorization verification result.

In an embodiment of the present application, the transaction processing method applied to the target biometric information server according to embodiments of the present application may further include: transmitting registered biometric characteristic information matching the biometric characteristic information to the authorization server, so that the authorization server can perform authorization verification on the transaction corresponding to the transaction request according to the registered biometric characteristic information.

After receiving a transaction request transmitted by the terminal device including the biometric characteristic information of the user and the transaction authorization verification mode depending on the biometric characteristic information, the authorization server acquires, from the biometric information server, registered biometric characteristic information of the user required by the transaction transaction verification mode; performs authorization verification on the transaction corresponding to the transaction request according to the registered biometric characteristic information and the biometric characteristic information included in the transaction request to obtain a transaction authorization verification result; and feeds back the transaction authorization verification result to the terminal device that transmits the transaction request. The terminal device performs the transaction according to the transaction authorization verification result.

Exemplarily, it is supposed that the terminal device A initiates a transaction request to an authorization server, and the transaction request includes facial information a of a user X and a transaction authorization verification mode required for authorization verification via the facial information. It should be understood that the transaction request may also include card information for the transaction. The authorization server acquires registered facial information b corresponding to the card information from the target biometric information server; uses the registered facial information b and the facial information a to perform authorization on the transaction. If the facial information b and facial information a refer to facial information of a same user, the authorization succeeds; but if the facial information b and the facial information a refer to facial information of different users, the authorization fails. The terminal device performs the transaction according to a transaction authorization verification result.

In an embodiment of the present application, the acquiring the biometric characteristic information of the user may include: receiving identity information transmitted by an intermediate biometric information server, wherein the identity information is identity information retrieved by intermediate biometric information server and is corresponding to registered biometric characteristic information matching the captured biometric characteristic information. The determining the card information of the user for feedback according to the biometric characteristic information may include: determining the card information of the user for feedback according to the received identity information.

In an embodiment of the present application, some functions of the target biometric information server may be implemented by another server (such as an intermediate biometric information server), such as the function of retrieving registered biometric characteristic information matching the captured biometric characteristic information. In view of this, the terminal device may transmit the biometric characteristic information to the intermediate biometric information server, and the intermediate biometric information server retrieves registered biometric characteristic information matching the captured biometric characteristic information, and then transmits identity information corresponding to the retrieved registered biometric characteristic information to the target biometric information server. The target biometric information server determines the card information of the user for feedback according to the received identity information. In an embodiment of the present application, the identity information includes but is not limited to: the user's mobile phone number, the user's identification number, etc.

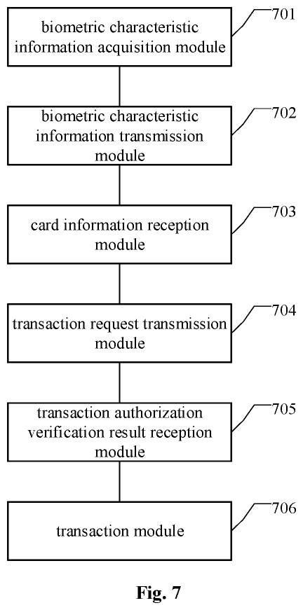

The embodiments of the application also provides a transaction processing method applied to an authorization server. FIG. 6 shows a schematic flowchart of a transaction processing method applied to an authorization server according to an embodiment of the present application. The transaction processing method applied to the authorization server may include:

S601: acquiring a transaction request, wherein the transaction request includes biometric characteristic information of a user and a transaction authorization verification mode depending on the biometric characteristic information;

S602: acquiring, from a target biometric information server, registered biometric characteristic information of the user required by the transaction authorization verification mode;

S603: performing authorization verification on a transaction corresponding to the transaction request according to the registered biometric characteristic information and the biometric characteristic information included in the transaction request to obtain a transaction authorization verification result;

S604: feeding back the transaction authorization verification result to a terminal device that transmits the transaction request, so that the terminal device performs the transaction according to the transaction authorization verification result.

The biometric characteristic information may include one or more of the following items: facial information, fingerprint information, voiceprint information, iris information and palmprint information.

After receiving a transaction request transmitted by the terminal device including the biometric characteristic information of the user and the transaction authorization verification mode depending on the biometric characteristic information, the authorization server acquires, from the target biometric information server, registered biometric characteristic information of the user required by the transaction authorization verification mode; performs authorization verification on the transaction corresponding to the transaction request according to the registered biometric characteristic information and the biometric characteristic information included in the transaction request to obtain a transaction authorization verification result; and feeds back the transaction authorization verification result to the terminal device that transmits the transaction request. The terminal device performs the transaction according to the transaction authorization verification result.

Exemplarily, it is supposed that the terminal device A initiates a transaction request to an authorization server, and the transaction request includes facial information a of a user X and a transaction authorization verification mode required for authorization verification via the facial information. It should be understood that the transaction request may also include card information for the transaction. The authorization server acquires registered facial information b corresponding to the card information from the target biometric information server; uses the registered facial information b and the facial information a to perform authorization on the transaction. If the facial information b and facial information a refer to facial information of a same user, the authorization succeeds; but if the facial information b and the facial information a refer to facial information of different users, the authorization fails. The terminal device performs the transaction according to a transaction authorization verification result.

In an embodiment of the present application, the transaction request includes: results of bioassary of the user. The authorization server performs authorization verification on the transaction corresponding to the transaction request based on the result of the bioassary, the registered biometric characteristic information and the biometric information included in the transaction request, so as to obtain the transaction authorization verification result.

In the transaction processing method applied to the authorization server according to the embodiment of the present application, the authorization server can perform authorization verification on the transaction corresponding to the transaction request, which can improve security of the user's funds.

Corresponding to the foregoing method embodiment, the embodiments of the present application also provides a transaction processing apparatus.

FIG. 7 shows a schematic structural diagram of a transaction processing apparatus applied to a terminal device according to an embodiment of the present application. The transaction processing apparatus applied to the terminal device includes:

a biometric characteristic information acquisition module 701 configured to acquire biometric characteristic information of a user;

a biometric characteristic information transmission module 702 configured to transmit the biometric characteristic information to a target biometric information server, so that the target biometric information server determines card information of the user according to the biometric characteristic information for feedback;

a card information reception module 703 configured to receive the card information of the user fed back by the target biometric information server;

a transaction request transmission module 704 configured to transmit a transaction request to an authorization server corresponding to the card information, so that the authorization server performs authorization verification on a transaction corresponding to the transaction request;

a transaction authorization verification result reception module 705 configured to receive a transaction authorization verification result fed back by the authorization server.

a transaction module 706 configured to perform the transaction according to the transaction authorization verification result.

In an embodiment of the present application, the transaction processing apparatus applied to a terminal device according to the embodiment of the present application may further include: a transaction verification capability transmission module configured to transmit transaction verification capability supported by the terminal device that captures the biometric characteristic information to the target biometric information server, so that the target biometric information server determines the card information of the user for feedback based on the transaction verification capability and a transaction authorization verification mode required by the authorization server.

In an embodiment of the present application, the transaction processing apparatus applied to a terminal device according to the embodiment of the present application may further include: an identification information transmission module configured to transmit identification information of the user to the target biometric information server, so that the target biometric information server retrieves registered biometric characteristic information corresponding to the identification information, determines whether the received biometric characteristic information and the retrieved registered biometric characteristic information refer to the same user, and determines card information corresponding to the retrieved registered biometric characteristic information as the card information of the user for feedback when the received biometric characteristic information and the retrieved registered biometric characteristic information refer to the same user.

In an embodiment of the present application, the transaction processing apparatus applied to a terminal device according to the embodiment of the present application may further include: a bioassary module configured to performing bioassay on the user, wherein the transaction request includes results of the bioassay.

In an embodiment of the present application, the biometric information transmission module 702 may be specifically configured to: transmit the biometric characteristic information to an intermediate biometric information server, so that the intermediate biometric information server retrieves registered biometric characteristic information matching the biometric characteristic information and transmits identity information corresponding to the retrieved registered biometric characteristic information to the target biometric information server, such that the target biometric information server determines the card information of the user for feedback according to the received identity information.

In an embodiment of the present application, the card information may include: original card information that has not been subject to a tokenization processing, or card tokenization Token information that has been subject to the tokenization processing.

In an embodiment of the present application, the transaction request transmission module 704 may be specifically configured to: transmit the transaction request to the authorization server corresponding to card information selected by the user from the card information fed back from the target biometric information server.

In an embodiment of the present application, the transaction request includes a transaction authorization verification mode selected by the user.

In an embodiment of the present application, the biometric characteristic information may include one or more of the following items: facial information, fingerprint information, voiceprint information, iris information and palmprint information.

FIG. 8 shows a schematic structural diagram of a transaction processing apparatus applied to a target biometric information server according to an embodiment of the present application. The transaction processing apparatus applied to the target biometric information server may include:

a biometric characteristic information acquisition module 801 configured to acquire biometric characteristic information of a user;

a card information determination module 802 configured to determine card information of the user for feedback according to the biometric characteristic information; and

a card information feedback module 803 configured to feed back the card information to a terminal device, so that the terminal device transmits a transaction request to an authorization server corresponding to the card information, receives a transaction authorization verification result fed back by the authorization server in response to the transaction request, and performs a transaction according to the transaction authorize verification result.

In an embodiment of the present application, the biometric characteristic information acquisition module 801 may be specifically configured to: receive the biometric characteristic information of the user transmitted by the terminal device. The and information determination module 802 may be specifically configured to: retrieve registered biometric characteristic information matching the biometric characteristic information; and determine the card information of the user for feedback based on the retrieved registered biometric characteristic information.

In an embodiment of the present application, the biometric characteristic information acquisition module 801 may be specifically configured to: receive identity information of the user transmitted by an intermediate biometric information server, wherein the identity information is identity information corresponding to registered biometric characteristic information that is retrieved by the intermediate biometric information server and corresponds to the biometric characteristic information. The card information determination module 802 may be specifically configured to determine the card information of the user for feedback according to the received identity information.

In an embodiment of the present application, the transaction processing apparatus applied to the target biometric information server according to the embodiment of the present application may further include: a transaction verification capability acquisition module configured to acquire transaction verification capability supported by the terminal device. The card information determination module 802 may be specifically configured to: determine the card information of the user for feedback according to the biometric characteristic information, the transaction verification capability and a transaction authorization verification mode required by the authorization server.

In an embodiment of the present application, the transaction processing apparatus applied to the target biometric information server according to the embodiment of the present application may further include: an identification information acquisition module configured to acquire identification information of the user. The card information determination module 802 may be specifically configured to: retrieve registered biometric characteristic information corresponding to the identification information; determine whether the received biometric characteristic information and the retrieved registered biometric characteristic information refer to the same use; and determine the card information of the user for feedback according to the retrieved registered biometric characteristic information when the received biometric characteristic information and the retrieved registered biometric characteristic information refer to the same user.

In an embodiment of the present application, the card information may include: temporary card tokenization Token information that has been subject to a tokenization processing.

In an embodiment of the present application, the card information determination module 802 can be specifically configured to: determine card information associated with registered biometric characteristic information matching the biometric characteristic information as the card information of the user for feedback.

In an embodiment of the present application, the transaction processing apparatus applied to the target biometric information server according to the embodiment of the present application may further include: an association relationship establishment module configured to: acquire biometric characteristic information of the user for registration and one or more pieces of card information of the user; and establish an association relationship between the registered biometric characteristic information of the user for registration and the one or more pieces of card information of the user.

In an embodiment of the present application, the transaction processing apparatus applied to the target biometric information server according to the embodiment of the present application may further include: a registered biometric characteristic information transmission module configured to: transmit registered biometric characteristic information matching the biometric characteristic information to the authorization server, so that the authorization server performs authorization verification on the transaction corresponding to the transaction request according to the registered biometric characteristic information.

In an embodiment of the present application, the biometric information may includes one or more of the following items: facial information, fingerprint information, voiceprint information, iris information, and palmprint information.

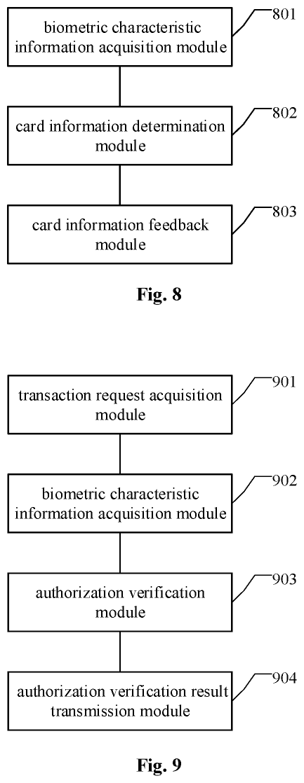

FIG. 9 shows a schematic structural diagram of a transaction processing apparatus applied to an authorization server according to an embodiment of the present application. The transaction processing apparatus applied to the authorization server include:20

a transaction request acquisition module 901 configured to acquiring a transaction request, wherein the transaction request includes biometric characteristic information of a user and a transaction authorization verification mode depending on the biometric characteristic information;

a biometric characteristic information acquisition module 902 configured to acquire, from a target biometric information server, registered biometric characteristic information of the user required by the transaction authorization verification mode;

an authorization verification module 903 configured to perform authorization verification on a transaction corresponding to the transaction request according to the registered biometric characteristic information and the biometric characteristic information included in the transaction request to obtain a transaction authorization verification result; and

an authorization verification result transmission module 904 configured to feed back the transaction authorization verification result to the terminal device that transmits the transaction request, so that the terminal device performs the transaction according to the transaction authorization verification result.

In an embodiment of the present application, the biometric characteristic information may include one or more of the following items: facial information, fingerprint information, voiceprint information, iris information and palmprint information.

In an embodiment of the present application, the transaction request may include: results of bioassay of the user.

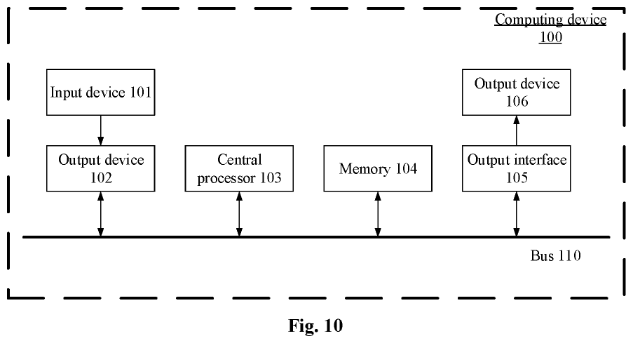

FIG. 10 shows a structural diagram of an exemplary hardware architecture of a computing device capable of implementing the transaction processing method and apparatus according to the embodiments of the present application. As shown in FIG. 10, the computing device 100 includes an input device 101, an input interface 102, a central processor 103, a memory 104, an output interface 105, and an output device 106. The input interface 102, the central processor 103, the memory 104, and the output interface 105 are connected to each other through a bus 110, and the input device 101 and the output device 106 are connected to the bus 110 through the input interface 102 and the output interface 105, respectively, and then connected to the other components of the computing device 100.

Specifically, the input device 101 receives input information from outside, and transmits the input information to the central processor 103 through the input interface 102; the central processor 103 processes the input information based on computer executable instructions stored in the memory 104 to generate output Information, wherein the output information is temporarily or permanently stored in the memory 104, and then is transmitted to the output device 106 through the output interface 105; the output device 106 outputs the output information to the outside of the computing device 100 for use by a user.

That is to say, the computing device shown in FIG. 10 may also be implemented as a transaction processing device. The transaction processing device include: a memory storing computer-executable instructions; and a processor that executes the computer-executable instructions to implement the transaction processing method and apparatus according to the embodiments of the present application.

The embodiments of the present application also provide a computer-readable storage medium having computer program instructions stored thereon; the computer program instructions are executed by a processor to implement the transaction processing method according to the embodiments of the present application.

Although the present application has been described with reference to the preferred embodiments, various modifications can be made without departing from the scope of the present application and the components therein can be replaced with their equivalents. In particular, as long as there is no structural conflict, the various technical features mentioned in the various embodiments can be combined in any manner. This application is not limited to the specific embodiments disclosed herein, but includes all technical solutions falling within the scope of the claims.

1. A transaction processing method, characterized in that the method comprises:
capturing biometric characteristic information of a user;
transmitting the biometric characteristic information to a target biometric information server, so that the target biometric information server determines card information of the user according to the biometric characteristic information for feedback;
receiving the card information of the user fed back by the target biometric information server;
transmitting a transaction request to an authorization server corresponding to the card information, so that the authorization server performs authorization verification on a transaction corresponding to the transaction request;
receiving a transaction authorization verification result fed back by the authorization server; and
performing the transaction according to the transaction authorization verification result.

2. The method according to claim 1, wherein the method further comprises:
transmitting transaction verification capability supported by a terminal device that captures the biometric characteristic information to the target biometric information server, so that the target biometric information server determines the card information of the user for feedback based on the transaction verification capability and a transaction authorization verification mode required by the authorization server.

3. The method according to claim 1, wherein the method further comprises:
transmitting identification information of the user to the target biometric information server, so that the target biometric information server retrieves registered biometric characteristic information corresponding to the identification information, determines whether the received biometric characteristic information and the retrieved registered biometric characteristic information refer to the same user, and determines card information corresponding to the retrieved registered biometric characteristic information as the card information of the user for feedback when the received biometric characteristic information and the retrieved registered biometric characteristic information refer to the same user.

4. The method according to claim 1, wherein the card information comprises:
original card information that has not been subject to a tokenization processing, or card tokenization Token information that has been subject to the tokenization processing.

5. The method according to claim 1, wherein the transmitting the biometric characteristic information to the target biometric information server comprises:
transmitting the biometric characteristic information to an intermediate biometric information server, so that the intermediate biometric information server retrieves registered biometric characteristic information matching the biometric characteristic information and transmits identity information corresponding to the retrieved registered biometric characteristic information to the target biometric information server, such that the target biometric information server determines the card information of the user for feedback according to the received identity information.

6. The method according to claim 1, wherein the transmitting the transaction request to the authorization server corresponding to the card information comprises:
transmitting the transaction request to the authorization server corresponding to card information selected by the user from the card information fed back from the target biometric information server.

7. The method according to claim 1, wherein the method further comprises:
performing bioassay on the user;
wherein the transaction request comprises results of the bioassay.

8. The method according to claim 1, wherein the transaction request comprises a transaction authorization verification mode selected by the user.

9. The method according to claim 1, wherein the biometric characteristic information comprises one or more of the following items: facial information, fingerprint information, voiceprint information, iris information and palmprint information.

10-22. (canceled)

23. A transaction processing apparatus, characterized in that the apparatus comprises a processor, a memory, and computer programs stored on the memory and executable on the processor, wherein the computer programs are executed by the processor to:
acquire biometric characteristic information of a user;
transmit the biometric characteristic information to a target biometric information server, so that the target biometric information server determines card information of the user according to the biometric characteristic information for feedback;
receive the card information of the user fed back by the target biometric information server;
transmit a transaction request to an authorization server corresponding to the card information, so that the authorization server performs authorization verification on a transaction corresponding to the transaction request;
receive a transaction authorization verification result fed back by the authorization server; and
perform the transaction according to the transaction authorization verification result.

24-26. (canceled)

27. A computer-readable storage medium, characterized in that computer-readable storage medium has computer programs stored thereon, and wherein the computer programs are executed by a processor to perform steps of the transaction processing method according to claim 1.

28. (canceled)

29. The apparatus according to claim 10, wherein the processor is further configured to:
transmit transaction verification capability supported by a terminal device that captures the biometric characteristic information to the target biometric information server, so that the target biometric information server determines the card information of the user for feedback based on the transaction verification capability and a transaction authorization verification mode required by the authorization server.

30. The apparatus according to claim 10, wherein the processor is further configured to:
transmit identification information of the user to the target biological information server, so that the target biological information server retrieves registered biological characteristic information corresponding to the identification information and determines whether the received biological characteristic information and the retrieved registered biometric characteristic information refers to the same user, and determines card information corresponding to the retrieved registered biometric characteristic information as the card information of the user for feedback when the received biological characteristic information and the retrieved registered biometric characteristic information refers to the same user.

31. The apparatus according to claim 10, wherein the card information comprises:
original card information that has not been subject to a tokenization processing, or card tokenization Token information that has been subject to the tokenization processing.

32. The apparatus according to claim 10, wherein the processor is further configured to:
transmit the biometric characteristic information to an intermediate biometric information server, so that the intermediate biometric information server retrieves registered biometric characteristic information matching the biometric characteristic information and transmits identity information corresponding to the retrieved registered biometric characteristic information to the target biological information server, such that the target biological information server determines the card information of the user for feedback according to the received identity information.

33. The apparatus according to claim 10, wherein the processor is further configured to:
transmit the transaction request to the authorization server, which is corresponding to card information selected by the user from the card information fed back from the target biological information server.

34. The apparatus according to claim 10, wherein t the processor is further configured to:
perform bioassay on the user;
wherein the transaction request comprises results of the bioassay.

35. The apparatus according to claim 10, wherein the transaction request comprises a transaction authorization verification mode selected by the user.

36. The apparatus according to claim 10, wherein the biometric characteristic information comprises one or more of the following items: facial information, fingerprint information, voiceprint information, iris information and palmprint information.
